(19) United States
(12) Patent Application Publication
(10) Pub. No.: US 2015/0372479 A1
(43) Pub. Date: Dec. 24, 2015

(54) COMPONENT PROTECTING DEVICE AND SAFETY CIRCUIT

(71) Applicant: Xiaomi Inc., Beijing (CN)

(72) Inventor: Xinqiu XIA, Beijing (CN)

(73) Assignee: Xiaomi Inc.

(21) Appl. No.: 14/128,829

(22) Filed: Dec. 23, 2013

Related U.S. Application Data
(63) Continuation of application No. PCT/CN2013/078992, filed on Jul. 8, 2013.

(30) Foreign Application Priority Data
Oct. 26, 2012 (CN) 201210419303.3

(51) Int. Cl. H02H 5/08

(52) U.S. Cl. CPC H02H 5/083

(57) ABSTRACT

A component protecting device includes a water-triggered conduction circuit and a switch circuit. The water-triggered conduction circuit includes a first conductor and a second conductor for coupling to a cathode of a power supply. The first conductor is not in contact with the second conductor, and the first and second conductors are configured to be conductively connected to each other by a conductive medium. The switch circuit includes an output terminal for coupling to a positive input terminal of a component to be protected, a first input terminal for coupling to an anode of the power supply, and a second input terminal coupled to the first conductor of the water-triggered conduction circuit.

### CROSS-REFERENCE TO RELATED APPLICATIONS

This application is a continuation of International Application No. PCT/CN2013/078992, filed on Jul. 8, 2013, which claims priority to Chinese Patent Application No. 201210419303.8, filed on Oct. 26, 2012, the entire contents of both of which are incorporated herein by reference.

### TECHNICAL FIELD

The present disclosure relates to the communications field and, more particularly, to a component protecting device and a safety circuit.

### BACKGROUND

With the development of technologies, electronic digital products have become very popular. For example, mobile phones are common communication tools used in people's daily life. These electronic digital products are internally provided with extremely precise circuits. In particular, main boards of the electronic digital products have a high density of circuits. Moreover, some circuit elements are very vulnerable. Therefore, in these electronic digital products, a momentary short circuit may cause permanent damage to the circuits. One of the major causes of damages to electronic digital products, such as mobile phones, is a short circuit caused by water entering the electronic digital product, which burns important components such as chips. Therefore, a good water-proof feature is an important measure of quality of electronic digital products.

A conventional solution to protect electronic digital product, such as mobile phones, against water is to add an electronic component, for example, a sensor, a trigger, and a relay, to a power supply circuit of an electronic digital product. Once the sensor detects the presence of water, the relay is triggered by the trigger to cut off the power supply circuit, so as to protect the main board.

In the above water-proof solution, the relay is large in size. In addition, the relay generally needs to be sealed to prevent water from entering the relay and causing failure of the relay. This also increases the size of the electronic digital product. For example, the thickness of the mobile phone may be increased. Therefore, it is unsuitable where thinner and lighter electronic digital products are desired.

### SUMMARY

In accordance with embodiments of the disclosure, there is provided a component protecting device. The component protecting device includes a water-triggered conduction circuit and a switch circuit. The water-triggered conduction circuit includes a first conductor and a second conductor for coupling to a cathode of a power supply. The first conductor is not in contact with the second conductor, and the first and second conductors are configured to be conductively connected to each other by a conductive medium. The switch circuit includes an output terminal for coupling to a positive input terminal of a component to be protected, a first input terminal for coupling to an anode of the power supply, and a second input terminal coupled to the first conductor of the water-triggered conduction circuit.

Also in accordance with embodiments of the disclosure, there is provided a safety circuit. The safety circuit includes a power supply, a component to be protected, a water-triggered conduction circuit, and a switch circuit. The water-triggered conduction circuit includes a first conductor, and a second conductor coupled to a cathode of the power supply and a negative output terminal of the component to be protected. The first conductor is not in contact with the second conductor, and the first and second conductors are configured to be conductively connected to each other by a conductive medium. The switch circuit includes an output terminal coupled to a positive input terminal of the component to be protected, a first input terminal coupled to an anode of the power supply, and a second input terminal coupled to the first conductor of the water-triggered conduction circuit.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1A schematically shows a component protecting device according to an embodiment of the present disclosure.

FIG. 1B schematically shows a water-triggered conduction circuit according to an embodiment of the present disclosure.

FIG. 1C schematically shows a water-triggered conduction circuit according to another embodiment of the present disclosure.

FIG. 2 schematically shows a component protecting device according to an embodiment of the present disclosure.

FIG. 3 schematically shows a component protecting device according to an embodiment of the present disclosure.

FIG. 4 schematically shows a component protecting device according to an embodiment of the present disclosure.

FIG. 5 schematically shows a component protecting device according to an embodiment of the present disclosure.

FIG. 6 schematically shows a safety circuit according to an embodiment of the present disclosure.

FIG. 7A schematically shows a safety circuit according to an embodiment of the present disclosure.

FIG. 7B schematically shows a safety circuit according to an embodiment of the present disclosure.

FIG. 8A schematically shows a safety circuit according to an embodiment of the present disclosure.

FIG. 8B schematically shows a safety circuit according to an embodiment of the present disclosure.

FIG. 9A schematically shows a safety circuit according to an embodiment of the present disclosure.

FIG. 9B schematically shows a safety circuit according to an embodiment of the present disclosure.

FIG. 10A schematically shows a safety circuit according to an embodiment of the present disclosure.

FIG. 10B schematically shows a safety circuit according to an embodiment of the present disclosure.

### DETAILED DESCRIPTION

Embodiments consistent with the disclosure include a component protecting device and a safety circuit.

Hereinafter, embodiments consistent with the disclosure will be described with reference to the drawings. Wherever possible, the same reference numbers will be used throughout the drawings to refer to the same or like parts.

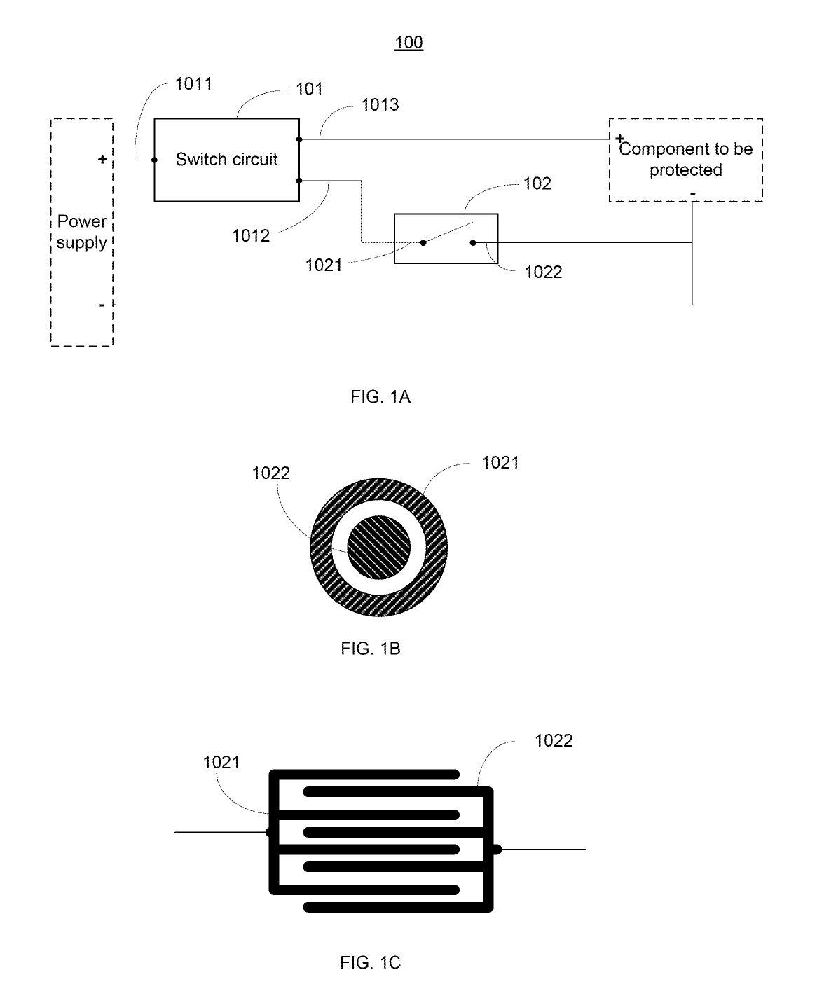

FIG. 1A schematically shows an exemplary component protecting device 100 consistent with embodiments of the present disclosure. For ease of description, FIG. 1A only illustrates portions related to the embodiments of the present disclosure. The component protecting device 100 may be used to protect the main board of an electronic digital product, such as a mobile phone, a personal digital assistant, or a digital camera. The component protecting device 100 includes a switch circuit 101 and a water-triggered conduction circuit 102. The switch circuit 101 includes a first input terminal 1011 configured to be coupled to an anode (indicated by symbol “+” in the figures) of a power supply, a second input terminal 1012, and an output terminal 1013 configured to be coupled to a positive input terminal (indicated by symbol “+” in the figures) of a component to be protected. The water-triggered conduction circuit 102 includes a first conductor 1021 coupled to the second input terminal 1012 of the switch circuit 101 and a second conductor 1022 coupled to a cathode (indicated by symbol “−” in the figures) of the power supply. The first conductor 1021 and the second conductor 1022 do not contact each other. When water enters the water-triggered conduction circuit 102 so that a conduction path is established between the first conductor 1021 and the second conductor 1022, the output terminal 1013 of the switch circuit 101 is disconnected from the first input terminal 1011 thereof.

The above power supply may be, for example, a DC power supply obtained by converting an AC power supply using an adapter, or a DC power supply provided by a battery inside the electronic product containing the component to be protected.

Consistent with embodiments of the present disclosure, the water-triggered conduction circuit 102 may be arranged in or near areas in the electronic product where water may relatively easily enter. For example, for mobile terminals such as mobile phones, an earphone jack, a Universal Serial Bus (USB) interface, a battery connector, an ON-OFF key, or a side key is an area that may be poorly sealed and that may allow a conductive medium, such as water, to easily enter the mobile phone. Therefore, the water-triggered conduction circuit 102 may be arranged in or near such an area. The first conductor 1021 and the second conductor 1022 of the water-triggered conduction circuit 102 may be two bare conductive wires or two bare metal conductive sheets. Shapes of the first conductor 1021 and the second conductor 1022 may be designed based on where the water-triggered conduction circuit 102 is located. FIGS. 1B and 1C schematically illustrate two examples of the water-triggered conduction circuit 102 according to embodiments of the present disclosure. During normal operation, since the first conductor 1021 and the second conductor 1022 of the water-triggered conduction circuit 102 do not contact each other, the water-triggered conduction circuit 102 is in a state equivalent to an “OPEN” state of a single pole switch, as symbolically shown in FIG. 1A. Once a conductive medium, such as water, enters one of the areas that are poorly sealed and allow water to easily enter into the electronic product, the entered water becomes a conductor connecting the first conductor 1021 and the second conductor 1022 of the water-triggered conduction circuit 102. As a result, the water-triggered conduction circuit 102 enters a state equivalent to a “CLOSED” state of a single pole switch.

As used in the present disclosure, the term “component to be protected” is a generic term, which may refer to, for example, a main board of an electronic product, or elements or a circuit on the main board. In general, when such a component to be protected comes into contact with water, a short circuit is likely to occur. The power supply may be a power supply providing power to the entire electronic product, for example, a lithium battery. Alternatively, the power supply may be a DC power supply obtained by converting an AC power supply using a power supply converter, such as an adapter.

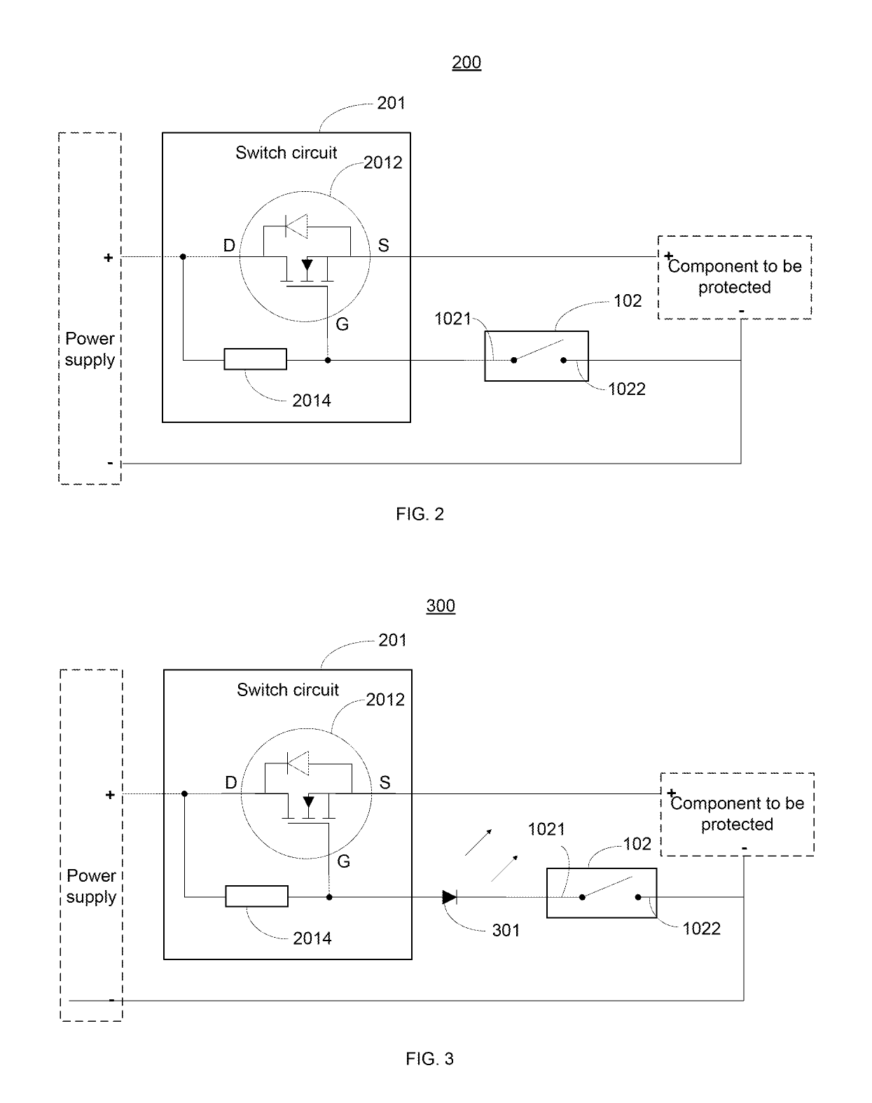

FIG. 2 schematically shows an exemplary component protecting device 200 according to embodiments of the present disclosure. In the component protecting device 200, a switch circuit 201 includes a field effect transistor (FET) 2012 and a resistor 2014. The FET 2012 may be an N-channel enhancement-mode metal-on-semiconductor (MOS) FET. A drain (denoted by letter “D” in the figures) of the FET 2012 is coupled to one terminal of the resistor 2014, and a gate (denoted by letter “G” in the figures) of the FET 2012 is coupled to another terminal of the resistor 2014. The drain of the FET 2012 corresponds to the first input terminal 1011 of the switch circuit 101, the gate of the FET 2012 corresponds to the second input terminal 1012 of the switch circuit 101, and a source (denoted by letter “S” in the figures) of the FET 2012 corresponds to the output terminal 1013 of the switch circuit 101.

In some embodiments, the resistor 2014 may be a resistor having a relatively large resistance value, for example, about 1 MΩ (mega-ohm). The resistor 202 may be a single resistor or combination of a plurality of resistors that are connected in series, in parallel, or in parallel series.

Consistent with embodiments of the present disclosure, when no water enters the water-triggered conduction circuit 102, the first conductor 1021 is disconnected from the second conductor 1022, the gate of the FET 2012 is pulled up to a high level, and the FET 2012 is turned on and capable of conducting current. Accordingly, the power supply provides power to the component to be protected as normal. Once the water-triggered conduction circuit 102 contacts a conductive medium, such as water, the water becomes a conductor between the first conductor 1021 and the second conductor 1022, and the water-triggered conduction circuit 102 becomes conductive. Therefore, the gate of the FET 2012 is pulled down to a low level, and the FET 2012 is turned off. As a result, the component to be protected is disconnected from the power supply, and is thus protected from being damaged.

FIG. 3 schematically shows an exemplary component protecting device 300 according to embodiments of the present disclosure. The component protecting device 300 is similar to the component protecting device 200 shown in FIG. 2, except that the component protecting device 300 further includes a light-emitting diode (LED) 301. An anode of the LED 301 is coupled to the gate of the FET 201, and a cathode of the LED 301 is coupled to the first conductor 1021 of the water-triggered conduction circuit 102. When water enters the water-triggered conduction circuit 102 to make it conductive, the LED 301 turns on and emits light, providing a visual indication to the user indicating water intrusion.

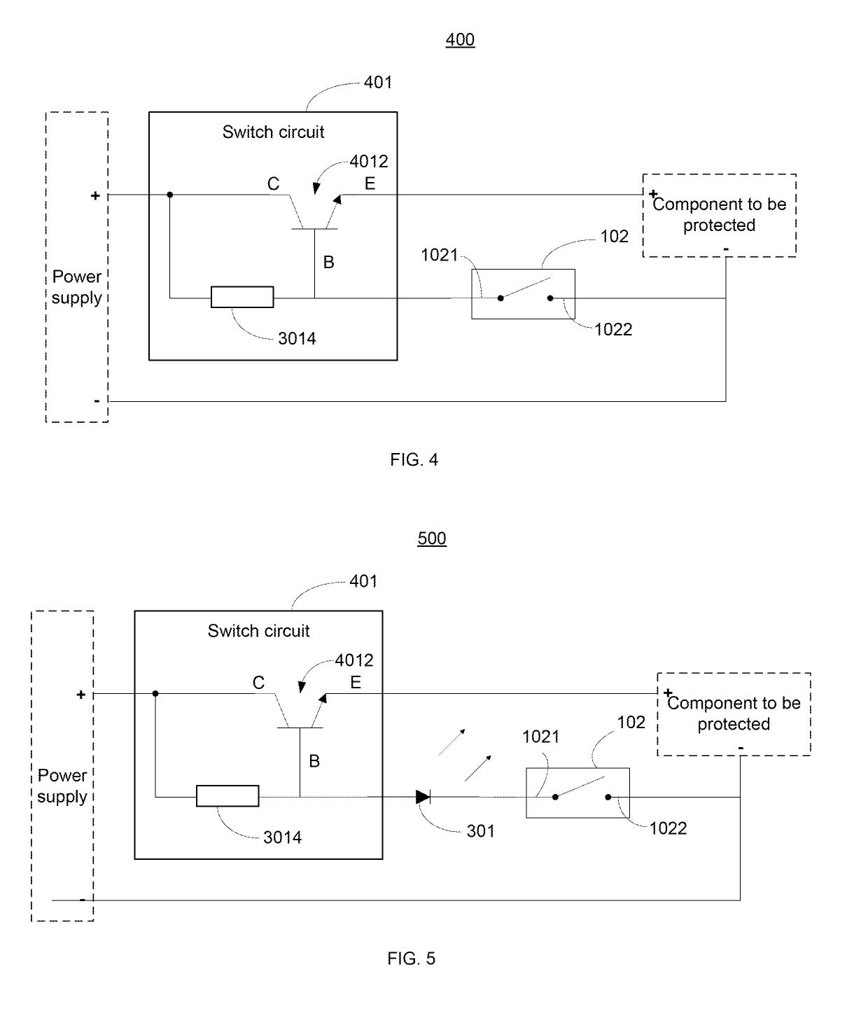

FIG. 4 schematically shows an exemplary component protecting device 400 according to embodiments of the present disclosure. The component protecting device 400 is similar to the component protecting device 200 shown in FIG. 2, except that in a switch circuit 401 of the component protecting device 400, a bipolar-junction transistor (BJT) 4012 is provided instead of the FET 2012 in the switch circuit 201 of the component protecting device 200. The BJT 4012 may be, for example, an NPN BJT, where a base (denoted by letter “B” in the figures) of the BJT 4012 is P-type, and an emitter (denoted by letter “C” in the figures) and a collector (denoted by letter “E” in the figures) of the BJT 4012 are N-type. The collector of the BJT 4012 is coupled to one terminal of the resistor 3014 and the base of the BJT 4012 is coupled to another terminal of the resistor 3014. The collector, the base, and the emitter of the BJT 4012 correspond to the first input terminal 1011, the second input terminal 1012, and the output terminal 1013 in FIG. 1A, respectively.

Consistent with embodiments of the present disclosure, when no water enters the water-triggered conduction circuit 102, the first conductor 1021 is disconnected from the second conductor 1022, the base of the BJT 4012 is pulled up to a high level, the BJT 4012 is in a reverse-active mode and conducts current between the collector and the emitter. Accordingly, the power supply provides power to the component to be protected as normal. Once the water-triggered conduction circuit 102 contacts a conductive medium, such as water, the water becomes a conductor between the first conductor 1021 and the second conductor 1022, and the water-triggered conduction circuit 102 becomes conductive. Therefore, the base of the BJT 4012 is pulled down to a low level, and the BJT 4012 is cut off. As a result, the component to be protected is disconnected from the power supply, and is thus protected from being damaged.

FIG. 5 schematically shows an exemplary component protecting device 500 according to embodiments of the present disclosure. The component protecting device 500 is similar to the component protecting device 400 shown in FIG. 4, except that the component protecting device 500 further includes the LED 301. As shown in FIG. 5, the anode of the LED 301 is coupled to the base of the BJT 4012, and the cathode of the LED 301 is coupled to the first conductor 1021 of the water-triggered conduction circuit 102. When water enters the water-triggered conduction circuit 102 to make it conductive, the LED 301 turns on and emits light, providing a visual indication to the user indicating water intrusion.

Consistent with embodiments of the present disclosure, since the water-triggered conduction circuit 102 and the switch circuit 101 do not occupy large space, as compared to conventional protection solutions, the component protecting device according to the embodiments of the present disclosure ensures that the electronic products can be made thinner. Moreover, consistent with embodiments of the present disclosure, before an electronic product with water intrusion is dried, even if a new battery is installed or the existing battery is being charged, the product cannot be powered up, and is thus protected from being further damaged.

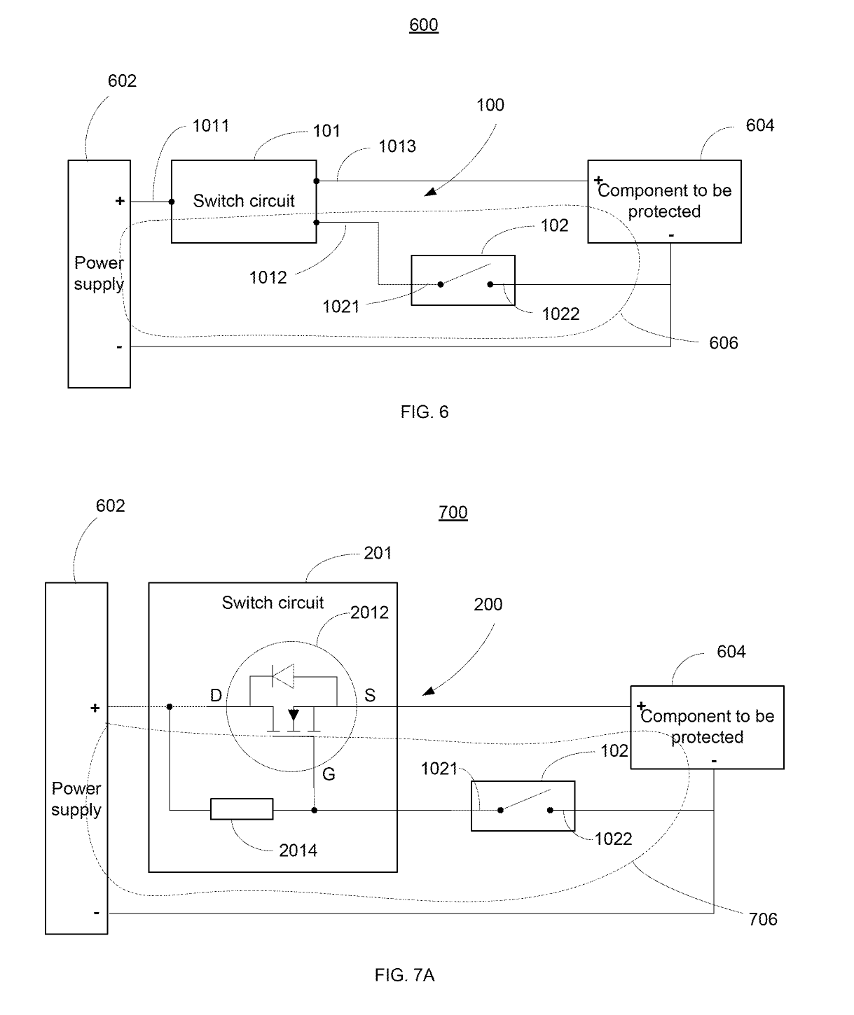

The component protecting device according to embodiments of the present disclosure may be combined with the power supply and the component to be protected to form a safety circuit. FIG. 6 schematically shows an exemplary safety circuit 600 according to embodiments of the present disclosure. For ease of description, FIG. 6 merely illustrates portions related to the embodiments of the present disclosure. The safety circuit 600 includes the component protecting device 100 shown in FIG. 1A, a power supply 602, and a component to be protected 604. The power supply 602, the switch circuit 101 in the component protecting device 100, and the component to be protected 604 form a power supply loop 606 (indicated by the dashed line in FIG. 6), over which the power supply 602 provides power to the component to be protected 604.

The switch circuit 101 and the component to be protected 604 are connected in series in the power supply loop 606. The first input terminal 1011 of the switch circuit 101 is coupled to an anode of the power supply 602. The first conductor 1021 of the water-triggered conduction circuit 102 is coupled to the second input terminal 1012 of the switch circuit 101. The second conductor 1022 of the water-triggered conduction circuit 102 is coupled to a negative output terminal of the component to be protected 604, and to a cathode of the power supply 602. When the water-triggered conduction circuit 102 comes into contact with water and becomes conductive, the output terminal 1013 of the switch circuit 101 is disconnected from the first input terminal 1011 of the switch circuit 101.

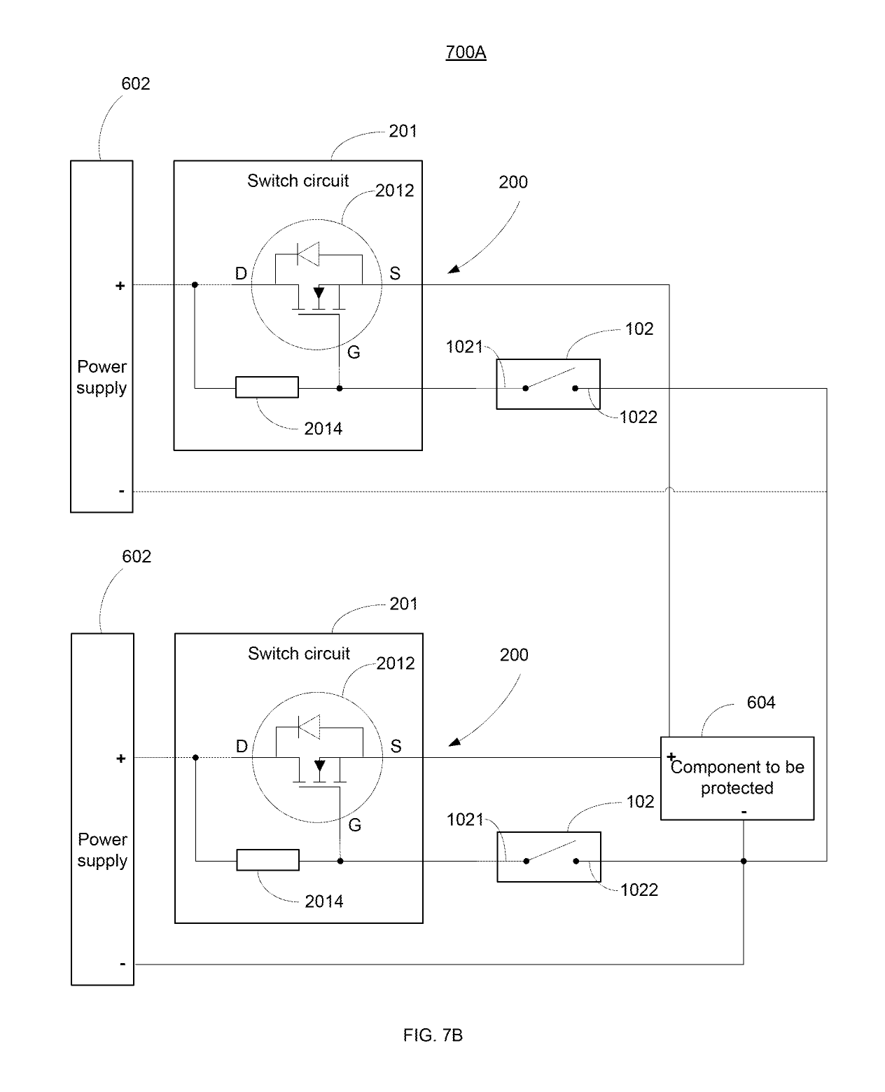

FIG. 7A schematically shows an exemplary safety circuit 700 according to embodiments of the present disclosure. The safety circuit 700 is similar to the safety circuit 600, except that the safety circuit 700 includes the component protecting device 200 shown in FIG. 2. In the safety circuit 700, the drain of the FET 2012 is coupled to the anode of the power supply 602, and the source of the FET 2012 is coupled to the positive input terminal of the component to be protected 604. The power supply 602, the switch circuit 201 in the component protecting device 200, and the component to be protected 604 form a power supply loop 706 (indicated by the dashed line in FIG. 7A), over which the power supply 602 provides power to the component to be protected 604. The switch circuit 201 and the component to be protected 604 are connected in series in the power supply loop 706.

Sometimes, multiple power supplies 602 may be provided. For example, one of the power supplies 602 may be a lithium battery and another one of the power supplies may be a DC power supply obtained by converting an AC power supply. FIG. 7B schematically shows an exemplary safety circuit 700A in which multiple power supplies 602 are provided according to embodiments of the present disclosure. The safety circuit 700A includes multiple switch circuits 201 and multiple water-triggered conduction circuits 102. Each of the multiple water-triggered conduction circuits 102 is configured to cut off one of the power supplies 602 when water intrusion occurs.

Since the FET 2012 is relatively small, to achieve better protection, the switch circuit 201 may be sealed. For example, during manufacture, the switch circuit 201 may be sealed by applying solid glue.

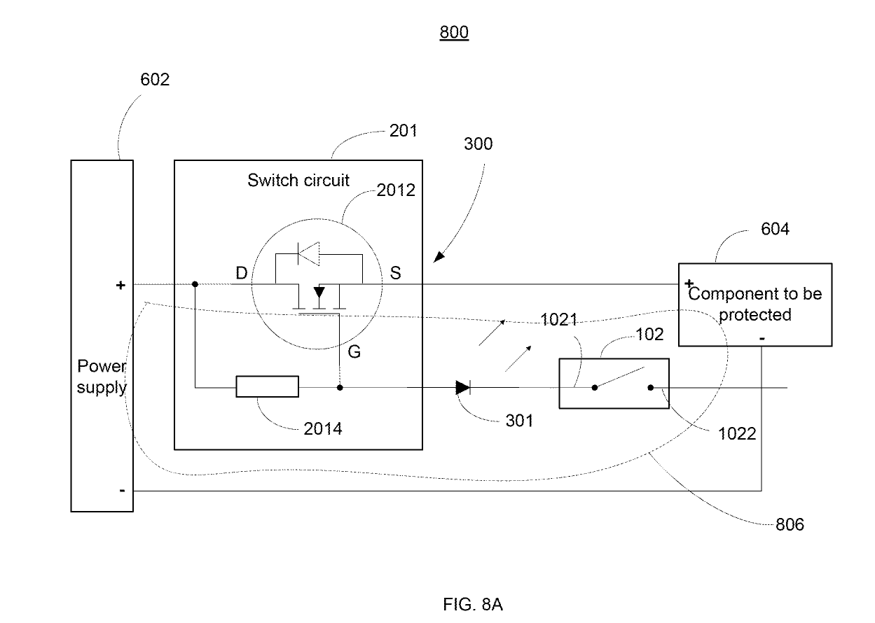

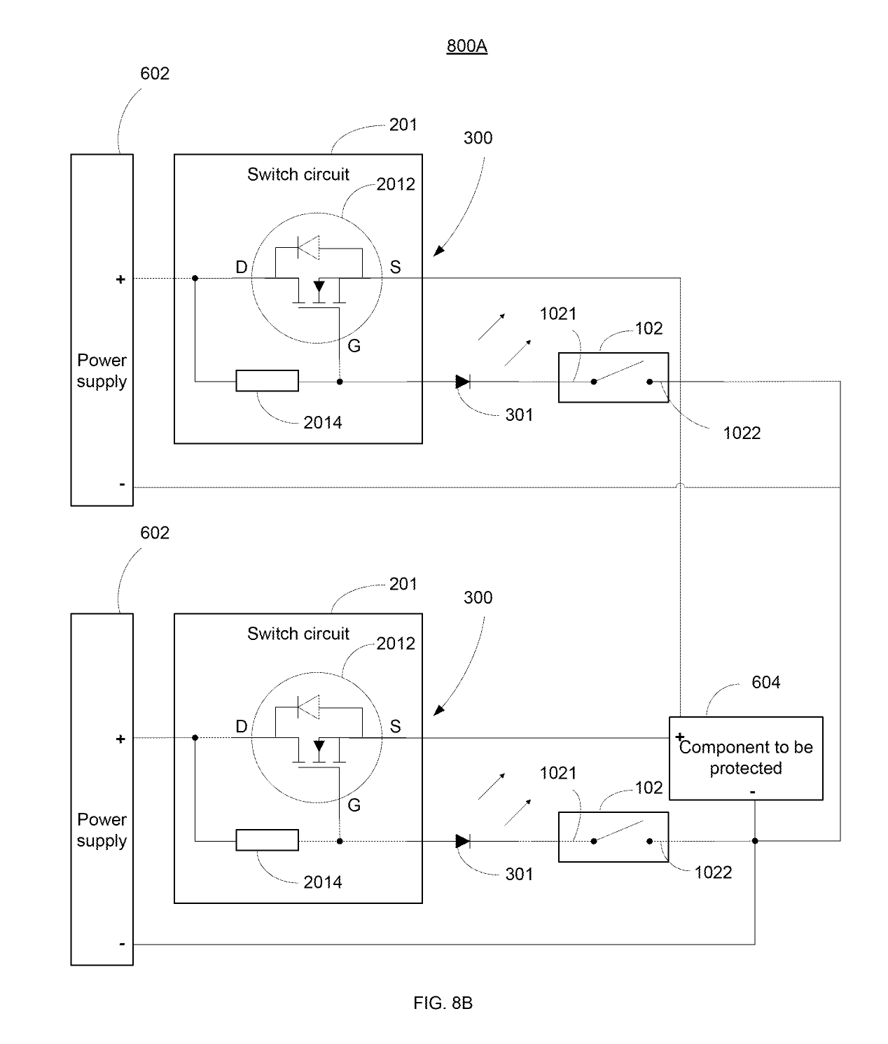

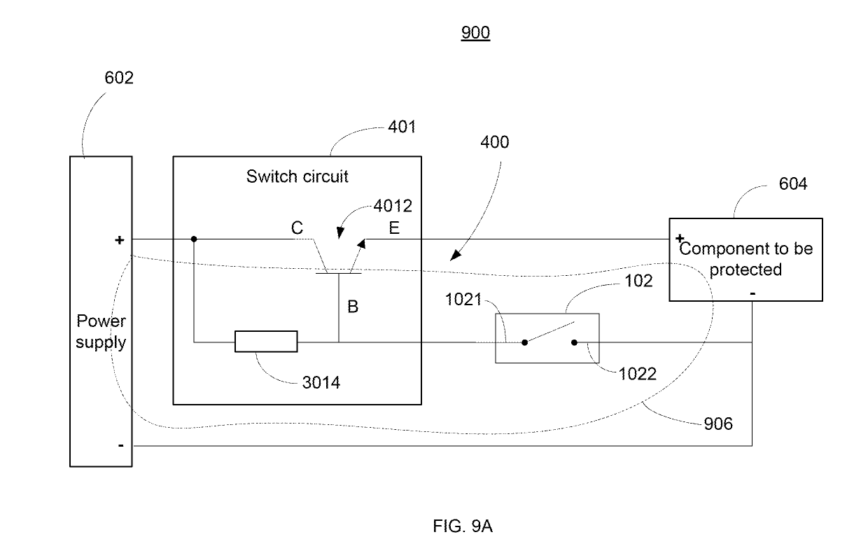

FIGS. 8A and 8B schematically show exemplary safety circuits 800 and 800A, respectively, according to embodiments of the present disclosure. The safety circuit 800 is similar to the safety circuit 700 shown in FIG. 7A, except that the safety circuit 800 further includes the LED 301. That is, the safety circuit 800 includes the component protecting device 300. In the safety circuit 800, the power supply 602, the switch circuit 201 in the component protecting device 300, and the component to be protected 604 form a power supply loop 806 (indicated by the dashed line in FIG. 8A), over which the power supply 602 provides power to the component to be protected 604. The switch circuit 201 and the component to be protected 604 are connected in series in the power supply loop 806.

The safety circuit 800A is similar to the safety circuit 700A shown in FIG. 7B, except that the safety circuit 800A further includes multiple LED's 301, each of which is coupled between one of the switch circuits 201 and one of the water-triggered conduction circuit 102.

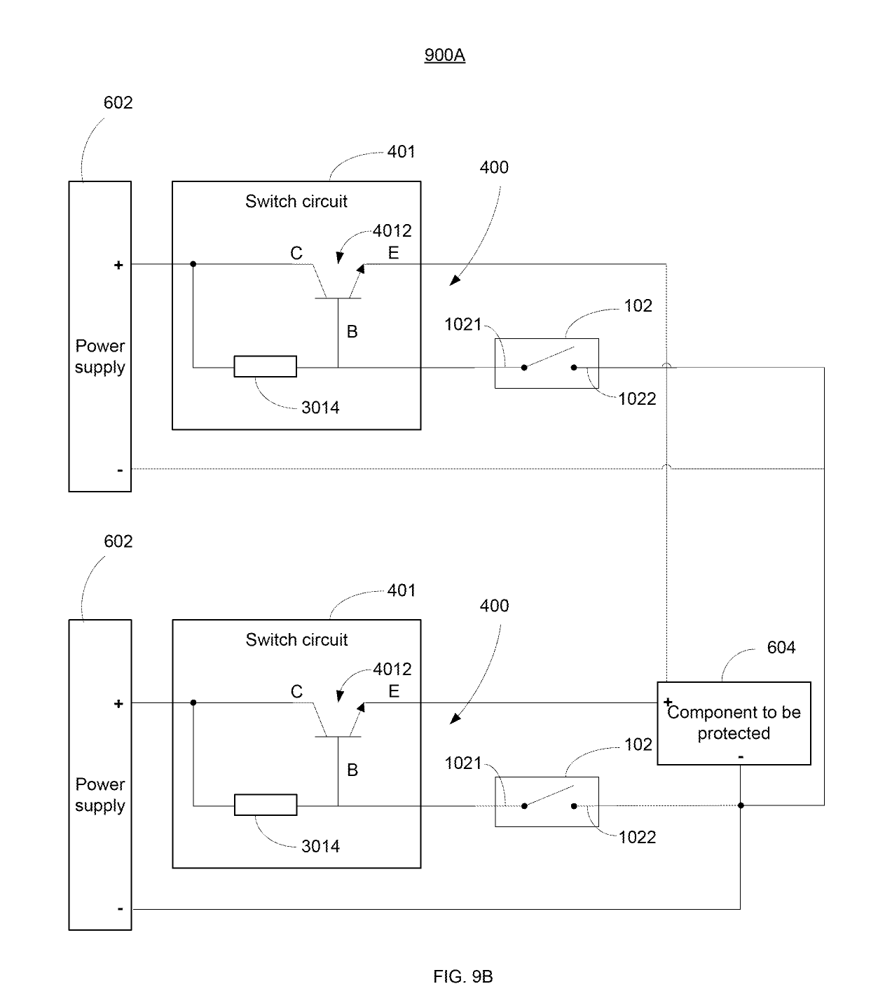

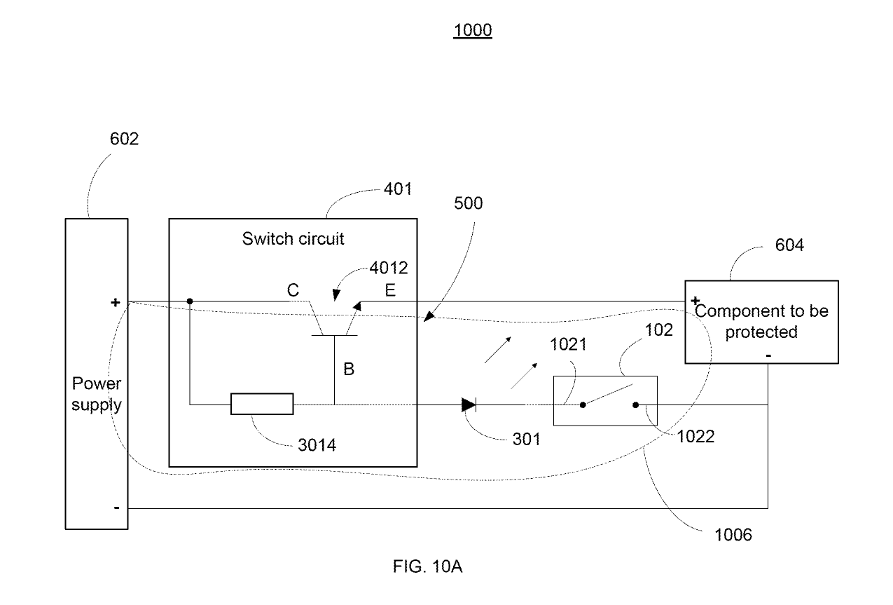

FIGS. 9A and 9B schematically show exemplary safety circuits 900 and 900A, respectively, according to embodiments of the present disclosure. The safety circuit 900 is similar to the safety circuit 700 shown in FIG. 7A, except that the safety circuit 900 includes the component protecting device 400, in which the switch circuit 401 includes the BJT 4012 instead of the FET 2012 shown in FIG. 7A. In the safety circuit 900, the power supply 602, the switch circuit 401 in the component protecting device 400, and the component to be protected 604 form a power supply loop 906 (indicated by the dashed line in FIG. 9A), over which the power supply 602 provides power to the component to be protected 604. The switch circuit 401 and the component to be protected 604 are connected in series in the power supply loop 906.

The safety circuit 900A is similar to the safety circuit 700A shown in FIG. 7B, except that in the safety circuit 900A, multiple switch circuits 401 are provided instead of multiple switch circuits 201 shown in FIG. 7B.

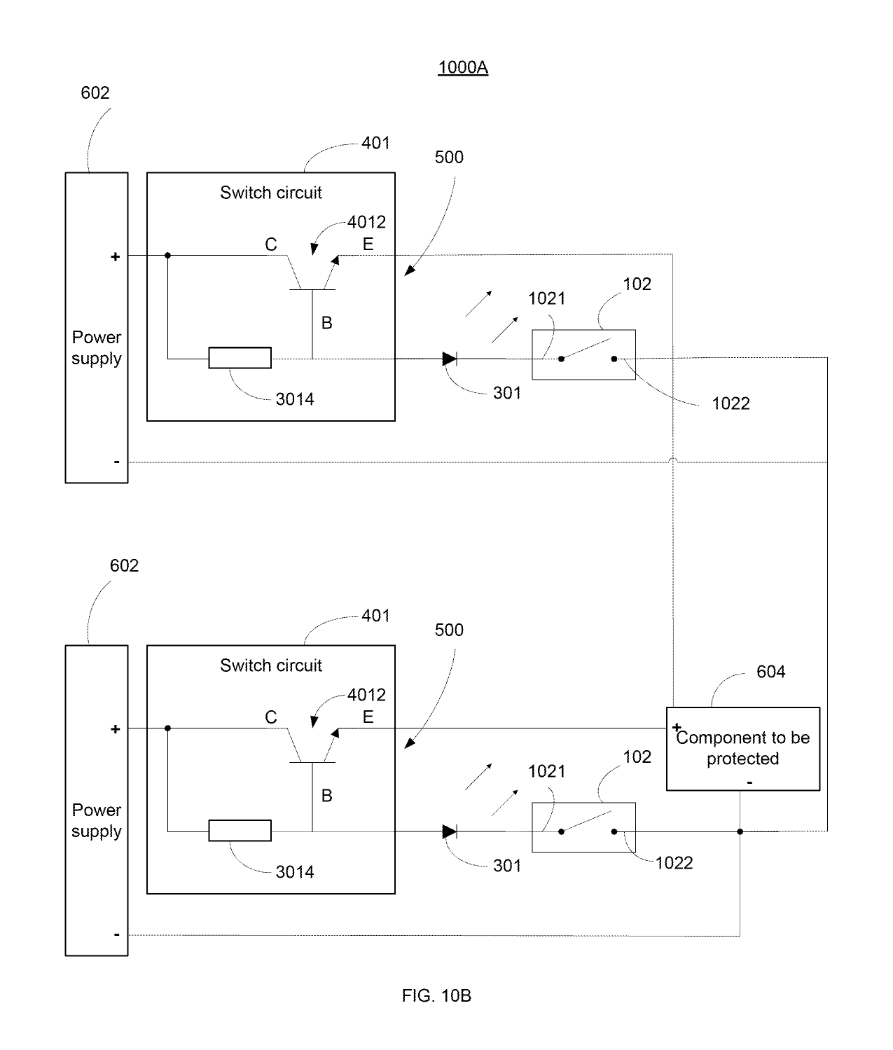

FIGS. 10A and 10B schematically show exemplary safety circuits 1000 and 1000A, respectively, according to embodiments of the present disclosure. The safety circuit 1000 is similar to the safety circuit 900 shown in FIG. 9A, except that the safety circuit 1000 further includes the LED 301. That is, the safety circuit 1000 includes the component protecting device 500. In the safety circuit 1000, the power supply 602, the switch circuit 401 in the component protecting device 500, and the component to be protected 604 form a power supply loop 1006 (indicated by the dashed line in FIG. 10A), over which the power supply 602 provides power to the component to be protected 604. The switch circuit 201 and the component to be protected 604 are connected in series in the power supply loop 806.

The safety circuit 1000A is similar to the safety circuit 900A shown in FIG. 9B, except that the safety circuit 1000A further includes multiple LED's 301, each of which is coupled between one of the switch circuits 401 and one of the water-triggered conduction circuit 102.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A component protecting device, comprising:
a water-triggered conduction circuit comprising:
a first conductor; and
a second conductor for coupling to a cathode of a power supply,
wherein:
the first conductor is not in contact with the second conductor, and
the first and second conductors are configured to be conductively connected to each other by a conductive medium; and
a switch circuit comprising:
an output terminal for coupling to a positive input terminal of a component to be protected;
a first input terminal for coupling to an anode of the power supply; and
a second input terminal coupled to the first conductor of the water-triggered conduction circuit.

2. The device according to claim 1, wherein:
the switch circuit further comprises:
a field effect transistor (FET) including:
a drain corresponding to the first input terminal of the switch circuit;
a gate corresponding to the second input terminal of the switch circuit; and
a source corresponding to the output terminal of the switch circuit; and
a resistor,
the drain of the FET is coupled to one terminal of the resistor, and
the gate of the FET is coupled to another terminal of the resistor,.

3. The device according to claim 2, further comprising:
a light-emitting diode (LED), an anode of the LED being coupled to the gate of the FET, and a cathode of the LED is coupled to the first conductor of the water-triggered conduction circuit.

4. The device according to claim 1, wherein:
the switch circuit comprises:
a bipolar-junction transistor (BJT) comprising:
a collector corresponding to the first input terminal of the switch circuit;
a base corresponding to a second input terminal of the switch circuit; and
an emitter corresponding to the output terminal of the switch circuit; and
a resistor,
the collector of the BJT is coupled to one terminal of the resistor, and
the base of the BJT is coupled to another terminal of the resistor.

5. The device according to claim 4, further comprising:
a light-emitting diode (LED), an anode of the LED being coupled to the base of the BJT, and a cathode of the LED being coupled to the first conductor of the water-triggered conduction circuit.

6. A safety circuit, comprising:
a power supply;
a component to be protected;
a water-triggered conduction circuit, comprising:
a first conductor; and
a second conductor coupled to a cathode of the power supply and a negative output terminal of the component to be protected,
wherein:
the first conductor is not in contact with the second conductor, and
the first and second conductors are configured to be conductively connected to each other by a conductive medium; and
a switch circuit comprising:
an output terminal coupled to a positive input terminal of the component to be protected;
a first input terminal coupled to an anode of the power supply; and
a second input terminal coupled to the first conductor of the water-triggered conduction circuit.

7. The safety circuit according to claim 6, wherein:
the switch circuit further comprises:
a field effect transistor (FET) including:
a drain corresponding to the first input terminal of the switch circuit;
a gate corresponding to the second input terminal of the switch circuit; and
a source corresponding to the output terminal of the switch circuit; and
a resistor,
the drain of the FET is coupled to one terminal of the resistor and the anode of the power supply, and
the gate of the FET is coupled to another terminal of the resistor.

8. The safety circuit according to claim 7, further comprising:
a light-emitting diode (LED), an anode of the LED being coupled to the gate of the FET, and a cathode of the LED is coupled to the first conductor of the water-triggered conduction circuit.

9. The safety circuit according to claim 6, wherein:
the switch circuit further comprises:
a bipolar-junction transistor (BJT) including:
a collector corresponding to the first input terminal of the switch circuit;
a base corresponding to a second input terminal of the switch circuit; and
an emitter corresponding to the output terminal of the switch circuit; and
a resistor,
the collector of the BJT is coupled to one terminal of the resistor and the anode of the power supply,
the base of the BJT is connected to another terminal of the resistor.

10. The safety circuit according to claim 9, further comprising:
a light-emitting diode (LED), an anode of the LED being coupled to the base of the BJT, and a cathode of the LED being coupled to the first conductor of the water-triggered conduction circuit.
